(19) United States
(12) Patent Application Publication
(10) Pub. No.: US 2008/0178863 A1
(43) Pub. Date: Jul. 31, 2008

(54) Self-extinguishing cooking system

(76) Inventor: Dannie O. Malafouris, Portland, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/699,275

(22) Filed: Jan. 26, 2007

(51) Int. Cl. A47J 37/07; B65D 33/16; B65D 33/00

(52) U.S. Cl. 126/25 C; 383/64; 383/105

(57) ABSTRACT

A self-extinguishing cooking system includes a barbecue grill with a pair of open topped fuel trays which are moveable between an open position where the grill can be cooked on and a closed position where the fuel trays abut one another. The fuel trays are placed in the closed position after the barbecue has been used to extinguish the remaining fuel in the fuel trays. A pouch, which is configured to receive the barbecue when it is in its closed position, is made from a double layer of fabric with a layer of air impervious material between them to reduce the amount of air that reaches the fuel when the barbecue is placed in the pouch.

### CROSS-REFERENCE TO RELATED APPLICATIONS

Self-extinguishing portable cooking systems are known in the prior art. Typically these systems include a portable barbecue which has a pair of fuel trays which when open hold the burning fuel, such as charcoal, that provides the heat for cooking. When closed the fuel trays reduce the amount of air that reaches the fuel and the fuel becomes extinguished due to lack of oxygen. Barbecues of this type are disclosed in White, U.S. Pat. No. 4,046,132, Malafouris, U.S. Pat. No. 4,133,335, Malafouris, U.S. Pat. No. 4,158,992, and pending application Ser. No. 11/213,228.

### BACKGROUND OF THE INVENTION

While all of these portable barbecues substantially limit the amount of air that reaches the fuel, they do not completely keep air out of the fuel trays so it takes longer to extinguish the fuel than it would if the air was completely eliminated. In addition, because the fuel trays are metal they are slow to cool, so even after the fuel is extinguished the barbecue remains hot and moving it creates a risk of being burned. Because of this the barbecue is placed in an air-tight, insulated pouch, which is configured to receive the barbecue. This causes the fuel to be extinguished more quickly and allows the barbecue to be safely moved before it has cooled. Pouches of this type are disclosed in Malafouris, U.S. Pat. No. 4,167,175.

The prior art pouches of this type have several shortcomings, however. First, the preferred material for making pouches is canvas or a canvas-like material. Canvas-like materials are rugged, somewhat heat resistant and air does not readily pass through them. Canvas is not completely impervious to air, however, so the pouches still do not cause the fuel to be extinguished as quickly as it would be if no air were allowed to reach it. In addition, the zippers in the prior art pouches, which allow the pouch to be opened to insert the barbecue into it, and then closed after the barbecue is in the pouch, run from one side of the pouch to the other. Thus, the end of the zipper is at the bottom of one side of the pouch which makes it easy to leave it partly open and admit air into the pouch. Finally, the sides of the prior art pouches are lined with an asbestos liner.

### BRIEF SUMMARY OF THE INVENTION

The subject invention overcomes the foregoing shortcomings of the prior art by providing a pouch for extinguishing fuel in a portable barbecue grill. The pouch has double layer fabric sidewalls with a layer of air impervious material between them.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a perspective view showing a barbecue grill in the open position.

FIG. 2 is a perspective view of a pouch embodying the subject invention.

FIG. 3 is a cross-sectional view taken along the lines 3-3 in FIG. 2, showing the barbecue grill in a closed position inside the pouch.

### DETAILED DESCRIPTION OF PREFERRED EMBODIMENT

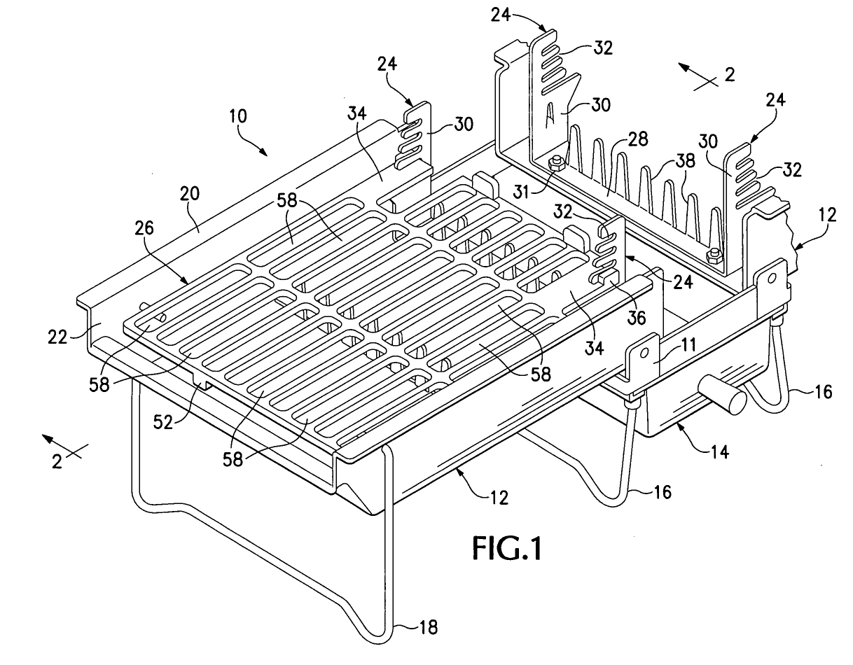

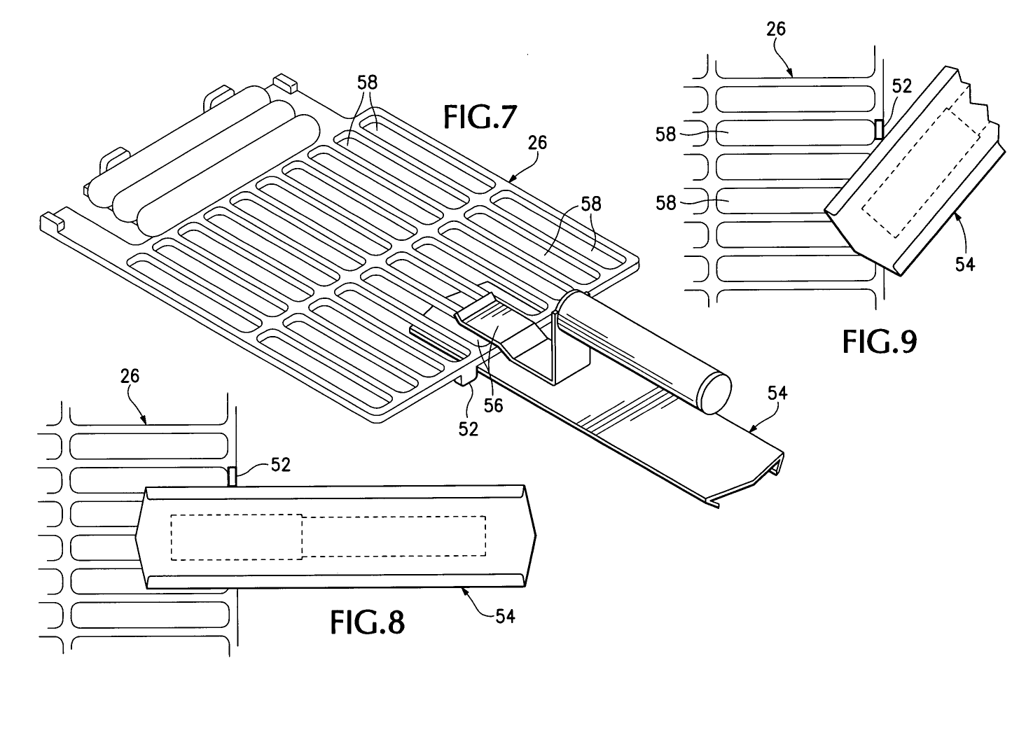

Referring now to the drawings, a portable barbecue grill 10 has two open-topped fuel trays 12 which are rotatably joined to a center section 14. The fuel trays rotate between an open position, FIG. 1, where the barbecue is available to cook on, and a closed position, FIG. 3, where the barbecue can be transported. Portable barbecues of this type are well known in the prior art. The embodiment illustrated in the drawings is described in detail in U.S. Pat. Nos. 4,046,132 and 4,133,335, and is exemplary of this type of barbecue. However, the outward appearance and details of the barbecue could be much different than what is illustrated. When the barbecue is in its closed position the open tops 15 of the two fuel trays 12 abut one another. A lid 16 is configured to be placed over the ends of the fuel trays when they are in their closed position and pull them tight against one another making them relatively air-tight. Thus, when the fuel trays are rotated to their closed position after cooking is completed unburned fuel (not shown) in the fuel trays is quickly extinguished due to the lack of oxygen.

However, it is difficult to make two opposed fuel trays of this type absolutely air-tight and as a result the fuel is not extinguished as quickly as it would be if it were more completely deprived of oxygen. In addition, the fuel trays 12 typically are cast iron and take a considerable amount of time to cool to the point where they can safely be touched.

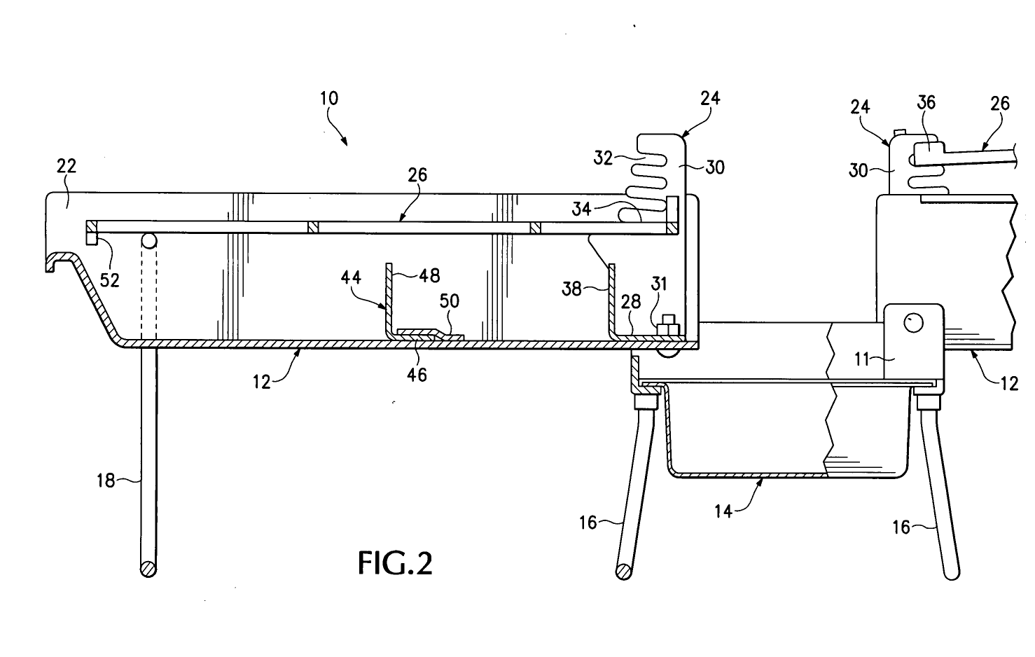

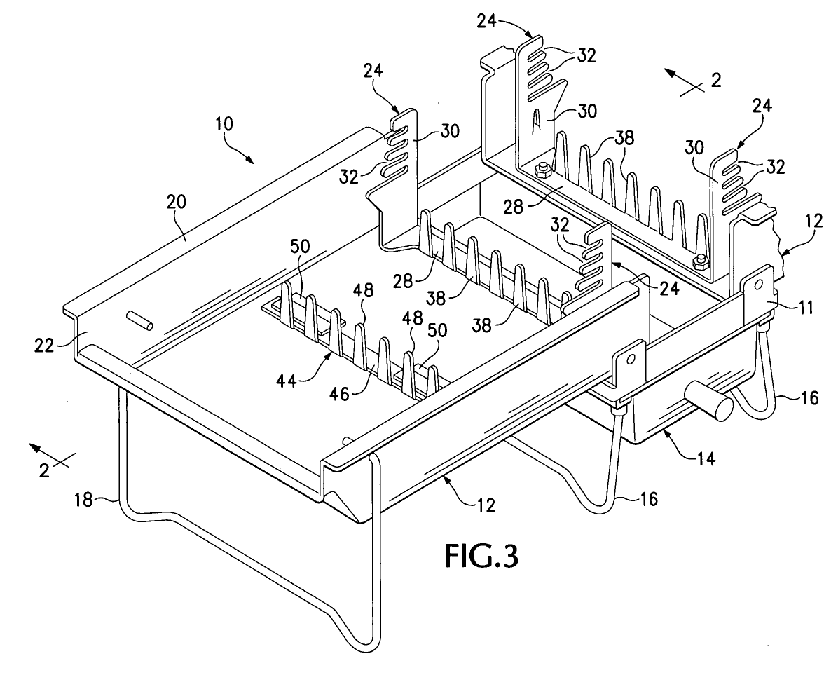

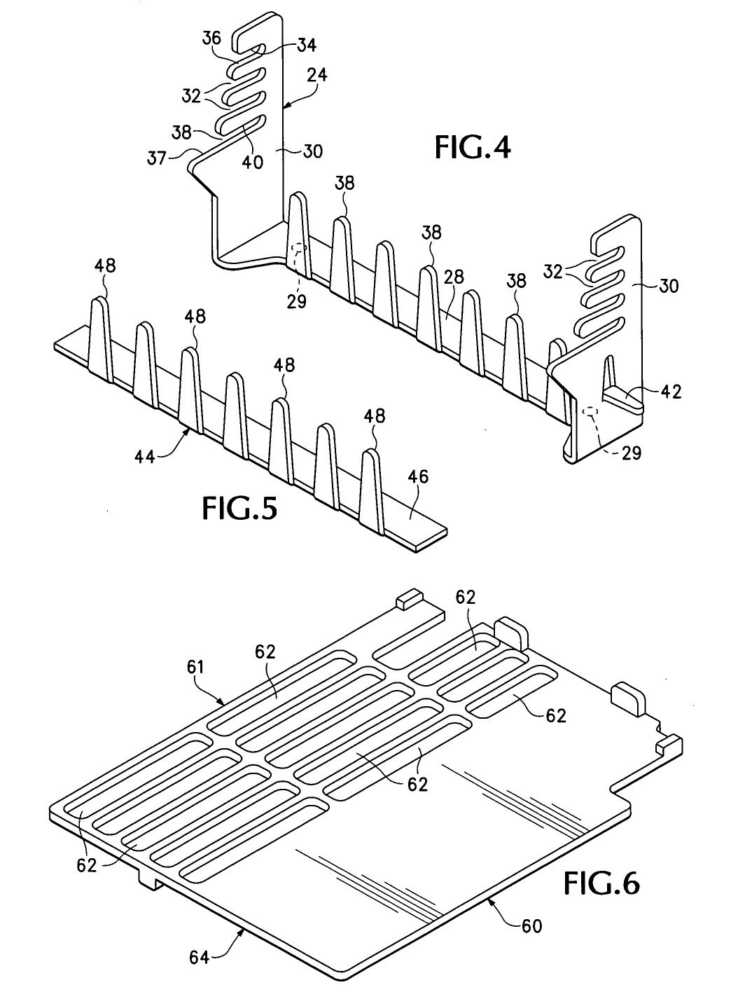

To remedy this the closed barbecue can be placed in an air-tight thermally insulated pouch. Pouches of this type are known in the prior art. An exemplary prior art pouch is described in U.S. Pat. No. 4,167,174. Referring now to FIGS. 2 and 3 of the drawings, the pouch 18 of the subject invention is an improvement over the prior art pouches in three significant respects. First, the preferred material for a pouch of this type is canvas or a canvas-like material. While canvas-like materials are relatively impermeable to air they are not completely impermeable. In order to make the pouch more impermeable to air, the subject pouch has two layers of fabric; an inner layer 20 and an outer layer 22. Located between the two layers of fabric is a layer of air impervious material 24. In a preferred embodiment the air impervious layer preferably is a coating which is applied to the surface of one of the fabric layers 20, 22. One way of accomplishing this is to spray coat the fabric with a liquid which will dry as an air impervious layer that is flexible enough to make the pouch useable.

The pouch shown in the drawings has two opposed side panels 26, a bottom 28 and a gusset 30 which extends between the side panels. In this embodiment both the side panels 26 and the gusset 30 utilize the double fabric with an impervious layer between them, so this material covers essentially the entire pouch. However, with other types of pouches sidewalls utilizing this feature may cover less than the entire extent of the pouch. A zipper 32 extends along the center of the gusset 30 to create an opening 34 in the pouch to allow the barbecue to be placed in it, FIG. 5. In order to facilitate completely closing the opening 34, the zipper has two zipper slides 36 which allows the final portion of the zipper closure to be at the top of the pouch where the zipper sliders are easily visible. Thus, it is less likely that the zipper will not be fully closed.

Located on the inside of both side panels 26 are layers of a fire-resistant material 38.

The terms and expressions which have been employed in the foregoing specification specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. A pouch for extinguishing burning fuel in a portable barbecue grill comprising:
(a) Sidewalls which cover a substantial portion of said pouch;
(b) said sidewalls including a double layer of fabric material with a layer of air impervious material located between them;
(c) said pouch having an opening which allows a portable barbecue grill to be placed therein; and
(d) a closure on said opening which substantially seals said pouch airtight when said grill has been placed therein.

2. The pouch of claim 2 wherein said air impervious material is a coating which has been applied to an inside surface of one of said layers of fabric.

3. The pouch of claim 1 including sheets of heat-resistant material which are attached to said sidewalls on the inside of said pouch.

4. The pouch of claim 1 wherein said closure is a zipper having two zipper slides which allows the zipper to be closed at any point along its extent.

5. A self-extinguishing cooking system comprises:
(a) A portable barbecue grill having a pair of open-topped fuel trays which are moveable between a cooking position where they extend horizontally outwardly from one another and a closed position where said open tops abut one another;
(b) a pouch which is configured to receive said portable barbecue grill in its closed position, said pouch including:
(i) sidewalls which cover a substantial portion of said pouch;
(ii) said sidewalls include a double layer of fabric material with a layer of air impervious material located between them;
(iii) said pouch having an opening which allows a portable barbecue grill to be placed therein; and
(iv) a closure on said opening which substantially seals said pouch air-tight when said grill has been placed therein.

6. The cooking system of claim 5 wherein said air impervious material is a coating which has been applied to an inside surface of one of said layers of fabric.

7. The cooking system of claim 5 including sheets of heat-resistant material which are attached to said panels on the inside of said pouch.

8. The cooking system of claim 5 wherein said closure comprises a zipper having two zipper slides which allows the zipper to be closed anywhere along its extent.
